(19) United States
(12) Patent Application Publication
(10) Pub. No.: US 2003/0197321 A1
(43) Pub. Date: Oct. 23, 2003

(54) Method and apparatus for forming groups of sheets from a plurality of sheets

(76) Inventor: Franz Schwab, Augsburg (DE)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/126,866

(22) Filed: Apr. 19, 2002

(51) Int. Cl. B41L 43/00

(52) U.S. Cl. 270/32

(57) ABSTRACT

In a method for forming groups of sheets from a plurality of sheets, initially two sheets are provided, respectively. The sheets are transferred into a common sheet track. If the sheets provided belong to the same group of sheets, these sheets are transferred into a collating station. Otherwise, one of the sheets is transferred into the collating station and the other one of the sheets is retained at a stop location.

### BACKGROUND OF THE INVENTION

1. Field of the Invention

The present invention relates to a method and an apparatus for forming groups of sheets from a plurality of sheets, in particular to a method and an apparatus for forming groups of sheets from a plurality of sheets of paper, which collate the individual groups of sheets using a paper merging device.

2. Description of the Prior Art

Paper-handling devices and/or collating equipment working with a merger, i.e. a paper joining device, are already known in the art. For example, such a merger is arranged upstream or downstream from a cutting machine and operates such that sheets, for example two printed sheets, which are arranged abreast of one another in the sheet conveying direction, are provided, and that the merger places the side-by-side papers and/or sheets on top of one another and subsequently outputs them to a directly connected collating station where the sheets are collated so as to form the individual groups of sheets.

Such a known system will briefly be explained below with reference to FIGS. 11 and 12.

FIG. 11A shows such a known paper-handling device 900 which includes a paper-feeding device 902, a paper-transferring device 904 (merger), a collating station 906 as well as a folding mechanism 908. The paper and/or sheet conveying direction, i.e. the direction in which the individual sheets pass through the device 900, is represented by the arrow P. To the sheet-feeding device 902 a paper web 910 is fed which is printed upon in a printer (not represented) in accordance with given data. Unit 902 further includes a cutting mechanism (not shown) which cuts the paper web 910, after it has been printed upon, in such a manner that two individual sheets 912 and 914 are formed from paper web 910, as is schematically shown in FIG. 11A. The individual sheets 912 and 914 are transferred from unit 902 to merger 904 which merges them from the side-by-side arrangement onto a common track. Sheets 912 and 914 are transferred from merger 904 to collating station 906 where the sheets received are collated onto a stack 916. If the number of sheets desired or the group of sheets desired is deposited in collating station 906, the stack 916 formed is passed on to the folding device 908 where the stack of sheets is folded correspondingly. Subsequently, the stack is introduced to further paper processing, e.g. inserting into an envelope or the like.

Further, FIG. 11A schematically represents, at 918, the control unit connected to the individual modules 902 to 908 and effects appropriate control of the overall device 900.

With reference to FIGS. 11B to 11F, the operation of device 900 in merging and/or collating so-called uneven groups of sheets will be explained in more detail below. “Uneven” group of sheets means that in the example represented in FIG. 11, the respective sheets belonging to an individual group of sheets are arranged in an offset manner in paper web 910, i.e. that even though two sheets are provided while paper web 910 is being cut, they belong to different groups of sheets in the exemplary case considered.

FIG. 11B represents the initial situation in which a previous group of sheets X has been collated in collating station 906. As can further be seen in FIG. 11B, another sheet of the sheets deposited in the previous step, which sheet belongs to group A and which is referred to a sheet A, is deposited at the input end of merger 904 which can be operated such that the sheets lying next to each other may be controlled individually. In paper-feeding device 902, sheets A′ and B, which have not been fully cut and belong to group A and group B, respectively, are present at the output end. Let us refer to this initial situation as phase 1, and the cycle time for forming group of sheets A starts in phase 1 at a time t=0 ms.

The subsequent more detailed discussion of the operation of device 900 will be effected with additional reference to FIG. 12 showing a flow chart for system 900 which represents the output times of the individual components of device 900 for unevenly-arranged groups of two sheets. In FIG. 12, the time is plotted in milliseconds against the x axis, and the corresponding output times of the individual components are plotted in the direction of the y axis, namely that of collating station 906, of merger 904 and of sheet-feeding device 902, the individual output times being provided with the respective sheets or groups of sheets so as to illustrate which sheets are being processed by which of the individual components. With regard to FIG. 12, it should further be pointed out that reference numerals 904R and 904L illustrate which of the sheets deposited in merger 904 is being moved, 904R referring to the sheet provided on the right-hand side in the paper conveying direction P with regard to the device's central axis Z, and 904L referring to the sheet provided on the left-hand side in the paper conveying direction P with regard to the device's central axis Z.

As can be seen in FIG. 12, moving stack X, the collation of which has already been completed, out of collating station 906 is initiated at the time t=0 ms, the duration for moving this stack out being 150 ms. Concurrently with the start of moving stack X out of collating station 906, a start is made to move sheet A, which is still provided at merger 904, through the latter, which takes 200 ms, as can be seen from FIG. 12 (see at 904L). Also concurrently with moving stack X out of collating station 906, sheet-feeding device 902 is activated so as to effect cutting of the paper web, which has already been printed upon at this stage, into individual sheets A′ and B, which takes 200 ms.

FIG. 11C represents phase 2—a situation as it presents itself after 150 ms, starting from the situation in FIG. 11B. As can be seen in connection with FIG. 12, at this time, sheet A is on its way from the input end of the merger to collating station 906, and sheets A′ and B have been almost fully cut by sheet-feeding device 902. As can further be seen from FIG. 11C, stack X is now already in folding mechanism 908, where corresponding folding is carried out. Further processing of stack X is of minor interest in the present case, further handling of the folded stack being usually effected, such as, for example inserting it into an envelope, or the like.

As has already been described above, passing on sheet A within merger 904 as well as cutting sheets A′ and B in sheet-feeding device 902, which, as has already been mentioned, takes 200 ms, is effected concurrently with starting to move stack X out. The situation presenting itself after this lapse of time is presented as phase 3 in FIG. 11D, and as can be seen, sheets A′ and B are now at the input end of merger 904, and sheet A has been transferred into collating station 906. After the transferral of sheet A to the collating station has been completed, the next sheet of this group of sheets, i.e. sheet A′, can now be transferred from the input end of the merger into the collator 906, as is represented in the time period from 200 ms to 400 ms in FIG. 12 (see reference numeral 904R). The situation presenting itself during the transfer of sheet A′ is shown in FIG. 11E as phase 4 at the time t=300 ms, and as can be seen, sheet B of the next group is still at the input end of merger 904, whereas sheet A′ of the current group is already on its way to collating station 906. At the time t=400 ms (see FIG. 12), sheet A′ is fully moved out of merger 904, i.e. contained in collator 906, as is also shown in phase 5 in FIG. 1F.

At the time when sheets B and A′ have been provided at the input end of merger 904, subsequent sheets B′ and C, which, however, have not been fully cut, are already provided at the output end of sheet-feeding device 902, as is further shown in FIGS. 11D to 11F.

The situation represented in FIG. 11F essentially corresponds to that in FIG. 11B, group X being replaced by group A, however, and the sheet provided in merger 904 now being sheet B.

As can be seen (see, in particular, FIG. 12), the total cycle time for forming group A is 400 ms.

The drawback to this known system is that in the processing of uneven groups, one sheet will always remain in merger 904, as can be seen in FIGS. 11B and 11E. As has already been explained above, an uneven group or an uneven group of sheets is a group wherein the individual sheets belonging to the group are arranged in an offset manner relative to paper web 910, as can be seen in group of sheets B with regard to individual sheets B and B′ in FIG. 11D. Such an offset results, for example from the fact that in the printer of sheet-feeding device 902, left-to-right printing is effected, which is why the end of the group is on the left-hand side in the paper conveying direction with regard to central axis Z. The consequence of the operation described using FIGS. 11 and 12 is that paper and/or sheets may not be fed again from paper-feeding device 902, which may be, for example, the cutting machine described above or a sheet leader, until collating station 906 has output the previous group and is receptive again. This results in a reduction in cycle performance in uneven groups, which is 50% in a collating quantity of two sheets.

DE 34 33 497 A1 describes a means for compiling sets of form sheets from form sheets belonging to one set. The compiling means consists of two receiving stations which are arranged side by side. The receiving stations each receive a form sheet from two paper-conveying tracks running parallel to one another, form sheets of the same set of form sheets being collated in one of the two receiving stations. For conveying the form sheets in the transverse direction, a special rotating conveying belt which is provided with perforations and is guided via a vacuum suction block is used, whereby the operating speed is to be increased while safety from operating failures is increased at the same time. In one configuration, one of the two receiving stations of the compiling means has a collating station connected downstream from it so as to feed it form sheets of a set of form sheets.

WO 88/00919 A relates to a device for merging folded printed items in a shingled formation onto a conveying means. The device essentially consists of a rotatably mounted drum with a plurality of compartments along the circumferential direction of the drum. The compartments are offset in the longitudinal direction of the drum and are arranged in two groups in an alternating manner in the circumferential direction of the drum such that both groups of compartments overlap by at least the width of one printed item. One slide of provided for each compartment, the slides being driven, by a specific device, such that the printed items located in the compartments are shifted from an input point, where the printed items are introduced side by side into the compartments of different groups, to an output point in the compartments such that the printed items at the output point are centred in relation to the transverse centre plane of the drum and are output from the compartments onto a downstream conveying belt in a shingled formation by gravity.

GB 1,009,263 A relates to creating gaps in a continuous stream of sheet articles, such as newspapers, so as to facilitate recognition of a specific number of consecutive sheet articles and therefore the formation of stacks of, for example 25 items each. For forming the gaps in the continuous stream of overlapping sheet articles, use is made of a hook-shaped gripper arm which is mounted such that it can swivel around a hinge in such a manner that, in a first position, it stops sheet articles and that, in a second position, it allows the continuous stream of sheets to pass.

U.S. Pat. No. 3,271,023 A relates to a sheet-collating device for collecting and/or collating sheet-like materials, such as pieces of cardboard. In particular, the device resolves the problem that in the case of freedom from defects, pieces of cardboard which are provided side by side may be output, one on top of the other, onto a stack or may, alternatively, in the case of a quality defect, may be output to separate collating points. In this way, the subsequent removal of one in three pieces of cardboard from the stack in the case that a cutting device damages one of the pieces of cardboard, such as the one which is always on the left-hand side in the conveying direction, is dispensed with. In the case of faultless pieces of cardboard, they are transferred, on three different conveying tracks arranged on three different levels, to come to lie on top of one another and are output into the stack. Otherwise, it is achieved, by adjusting suitable redirecting means, that all three pieces of cardboard continue to be output, via the same central conveying track, side by side so that only the central piece of cardboard comes to lie on the stack.

GB 918,709 A describes a device for stacking flat workpieces, such as pieces of cardboard, in counted stacks of, for example 100 items each. In this device, individual pieces of cardboard are stacked, in a manner such that they abut at a stopper arm, until the predetermined number for each stack has been reached, whereupon the stopper arm is lifted and the stack formed is continued to be conveyed onto the conveying means.

EP 0 869 092 A1 discloses a method and an apparatus for producing printed items enabling an optional continued conveyance of sheets printed two-up, after processing by suitable knives, in a manner such that they are rotated by 90° and disposed behind one other in one or several rows, via a common conveying section, either straight on to further processing, or in a vertical direction leading to a different further processing. By this optional continued conveyance either in a direction of a first processing means or of a second reprocessing means, variable adjustment of a book production device to variable format sizes is achieved.

WO 93/15006 A1 describes a method and an apparatus for automatic sorting of sheet-shaped objects into bundled groups. The device includes an aligning and conveying section, wherein the objects to be processed may be introduced from one of two different directions, so as to continue to be conveyed to a grouping section with one edge abutting against a side beam. At the start of the grouping section an interruption and lifting device is located which lifts, via rolls, the trailing parts of the objects while it slows them down via a roll at the leading edges, so as to enable the objects which follow in each case to slide underneath. In this way, a shingled arrangement of the objects is created downstream from the device. Subsequently, the objects which are arranged in a shingled manner arrive at a grouping device where the flow of mutually overlapping objects may be stopped so as to effect an interruption of the flow. Finally, the stacking device is located downstream from the grouping device. In order to facilitate stacking of the sheets in the stacking device, the grouping device is not actuated until a predetermined number of objects have been slid beneath the bundle. When a sufficient number of objects pass through the grouping device, the grouping device is actuated so as to interrupt the stream of objects upstream from the stacking device. After the last object has been slid beneath the bundle, the bundle is output from the stacking device, the grouping device being controlled at the same time to end the interruption of the stream of objects.

Thus, a need exists for an improved method and an improved device for forming groups of sheets from a plurality of sheets, which makes it possible to increase the cycle performance in forming the individual groups.

### SUMMARY OF THE INVENTION

The present invention is a method for forming groups of sheets from a plurality of sheets, in which (a) at least two sheets, respectively are provided, (b) if the sheets provided in step (a) belong to the same group of sheets, these sheets are transferred into a common sheet track and into a collating station, and in which (c) otherwise the sheet of a previous group of the sheets are transferred into a common sheet track and moved in the direction of a stop location, at an offset in timing as against the sheet of the previous group, the other sheet of a subsequent group of the sheets is transferred into a common sheet track, moved in the direction of the stop location, and, as soon as the sheet of the previous has reached the stop location, moved into the collating station. The other sheet is retained in the stop location. The offset in timing is such that shortly after the sheet of the previous group has been output into the collating station, the sheet of the subsequent group is inserted into the stop location.

Further, the present invention is a method for forming groups of sheets from a plurality of sheets, in which (a) at least two sheets, respectively, are provided, (b) if the sheets provided in step (a) belong to the same group of sheets, these sheets are transferred into a common sheet track and through a double-storey stop location into a collating station, and in which (c) otherwise the sheets are simultaneously transferred into a common sheet track, and the sheets are fed into the double-storey stop location in a form in which they are arranged on top of each other, then the sheet of a previous group of the sheets is moved out of the double-storey stop location into the collating station, and the other sheet of a subsequent group is retained in the double-storey stop location. Then the sheet of the previous group is moved out of the collating station, and the sheet of the subsequent group is moved out of the double-storey stop location into the collating station in a manner offset in time as against the sheet of the previous group.

The present invention is also an apparatus for forming groups of sheets from a plurality of sheets. The apparatus has a sheet-feeding means, wherein two sheets are arranged, for providing the sheets, a sheet-transferring means for transferring the sheets into a common sheet track, a stop location means receiving one or several sheets from the sheet-transferring means, a collating station collating sheets of a group of sheets, and a control means which if the sheets provided by the sheet-feeding means belong to the same group of sheets effects the transferral of these sheets into a common sheet track and into a collating station, and otherwise the transferral of the sheet of a previous group of the sheets into a common sheet track and the moving of same in the direction of a stop location, at an offset in timing as against the sheet of the previous group, the transferral of the other sheet of a subsequent group of the sheets into a common sheet track and the moving of same in the direction of the stop location, as soon as the sheet of the previous group has reached the stop location, the moving of same into the collating station, retaining the other sheet in the stop location, the offset in timing being such that shortly after the sheet of the previous group has been output into the collating station, the sheet of the subsequent group is inserted into the stop location.

The present invention is also an apparatus for forming groups of sheets from a plurality of sheets. The apparatus has a sheet-feeding means wherein two sheets are arranged, for providing the sheets, a sheet-transferring means for transferring the sheets into a common sheet track, a stop location means receiving one or several sheets from the sheet-transferring means, a collating station collating sheets of a group of sheets, and a control means which if the sheets provided by the sheet-feeding means belong to the same group of sheets effects the transferral of these sheets into a common sheet track and through a double-storey stop location into a collating station, and otherwise effects the simultaneous transferral of the sheets into a common sheet track and the feeding of the sheets into the double-storey stop location, the moving of the sheet of a previous group of the sheets out of the double-storey stop location into the collating station and the retention of the other sheet of a subsequent group in the double-storey stop location; and the moving of the sheet of the previous group out of the collating station, and the moving of the sheet of the subsequent group out of the double-storey stop location into the collating station in a manner offset in time as against the sheet of the previous group.

The present invention is based on the findings that a pronounced increase in performance in collating devices for paper, as have been described above with reference to FIGS. 11 and 12, can be achieved by inserting a stop location upstream from the collating station, it being possible, for example that this stop location is provided for one sheet or for two sheets placed on top of each other. By inserting the stop location, which is capable of transporting and buffering a sheet or two sheets placed on top of each other, it is achieved that, in the case of an uneven group of sheets (see above), a precursor, e.g. a merger, is receptive again at an earlier point in time, since the first sheet of the subsequent group of sheets is stopped at the stop location (buffer).

By means of the inventive arrangement of the stop location and/or by the inventive retention of the sheet of a subsequent group it is achieved that, instead of the operation apparent from FIG. 12, an “overlapping” operation of the individual components can be achieved, so that provision of further sheets may be started early, so that considerable savings in the cycle time required for forming a group result from this overlapping mode of operation.

In accordance with a first preferred embodiment, the inventive stop location is arranged between a merger and a collating station, the sheet-feeding device including a cutting means and a printer.

In accordance with a second embodiment of the present invention, the stop location is arranged between the sheet-feeding means and the collating station, the sheet-feeding means being arranged, in this embodiment, such that it receives two paper webs arranged parallel with each other, prints onto them, merges them from the side-by-side arrangement onto a common paper track and cuts them so that the sheets to be grouped of the individual webs are arranged on top of one another at the output end of the paper-feeding device.

In a third embodiment, the device is designed such that the individual sheets are deposited at a sequence sorter by a sheet-feeding device in the form of a cutting and printing means, wherein the two sheets are provided side by side in a first paper conveying direction, are transferred into the sequence sorter and are moved from the latter into a collating station via the inventive stop location, arranged upstream from the collating station, in a second paper conveying direction which is preferably perpendicular to the first paper conveying direction.

In accordance with an embodiment of the present invention, the sheets provided are merged onto a common track such that they are either arranged behind one other in a non-shingled manner in the sheet conveying direction, that they are arranged behind one other in a shingled manner in the sheet conveying direction, or that they are arranged on top of one other in the sheet conveying direction.

In accordance with a further embodiment of the present invention, a further stop location is provided between the sheet-feeding device and the merger in addition to the above stop location, whereby further improvement in the cycle performance can be achieved, since in this way, the feeding operation to the merger is decoupled from the operation of the cutting device. This additional stop location receives the sheets provided, which exhibits the advantage that, in the case of a merger already filled, paper can immediately be fed again in an accelerated manner from the paper-feeding device and that paper can immediately be reloaded when requested by the merger i.e. that no unnecessary time losses due to the time-consuming cutting operation (approximately 20 ms) result.

The advantage of the present invention is that in processing uneven groups, the cycle performance of the paper-handling system can be substantially increased in comparison with devices known from the prior art.

### BRIEF DESCRIPTION OF THE DRAWINGS

In the following, preferred embodiments of the present invention will be described in more detail with reference to the accompanying drawings, in which:

FIGS. 1A to F show a schematic representation of a first embodiment of the inventive device and of the inventive method;

FIG. 2 shows a first flow chart showing the output times of the individual components of the device of FIG. 1A in accordance with a first configuration of this device;

FIG. 3 shows a second flow chart showing the output times of the individual components of the device of FIG. 1A in accordance with a second configuration;

FIGS. 4A to D show a schematic representation of a second embodiment of the inventive device and of the inventive method;

FIG. 5 shows a third flow chart showing the output times of the individual components of the device of FIG. 1A;

FIG. 6 shows a tabular record of the sheet numbers achievable with the present invention in comparison with those of a conventional system;

FIGS. 7A to E show a schematic representation of a third embodiment of the inventive device and of an inventive method;

FIG. 8 shows a fourth flow chart showing the output times of the individual components of the device of FIG. 7A;

FIGS. 9A to D show a schematic representation of a further embodiment of the inventive device and of the inventive method;

FIGS. 10A to D show a schematic representation of a further embodiment of the inventive device and of the inventive method;

FIGS. 11A to F show a schematic representation of a known device for forming groups of sheets; and

FIG. 12 shows a flow chart showing the output times of the individual components of the device of FIG. 11A.

### DESCRIPTION OF THE PREFERRED EMBODIMENTS

In the following description of the preferred embodiments of the present invention, similar components and elements, or components and elements which operate in the same manner, are given the same reference numerals.

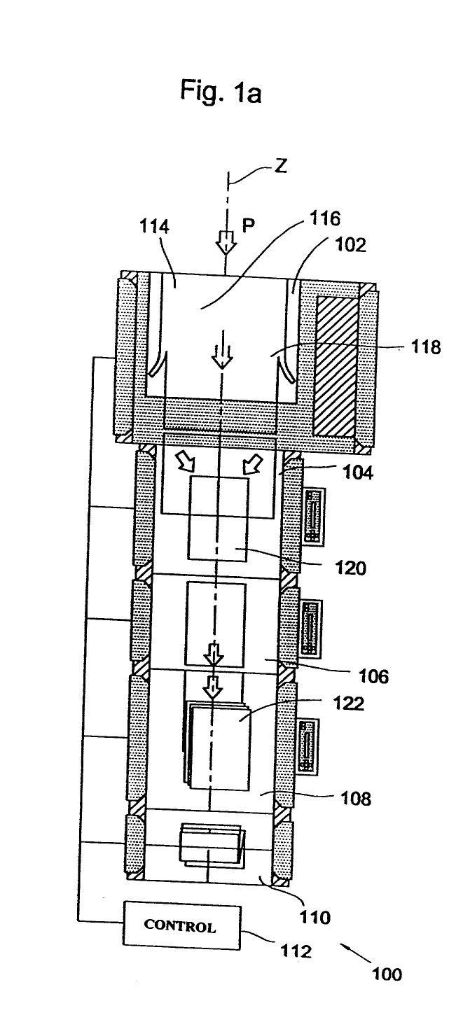

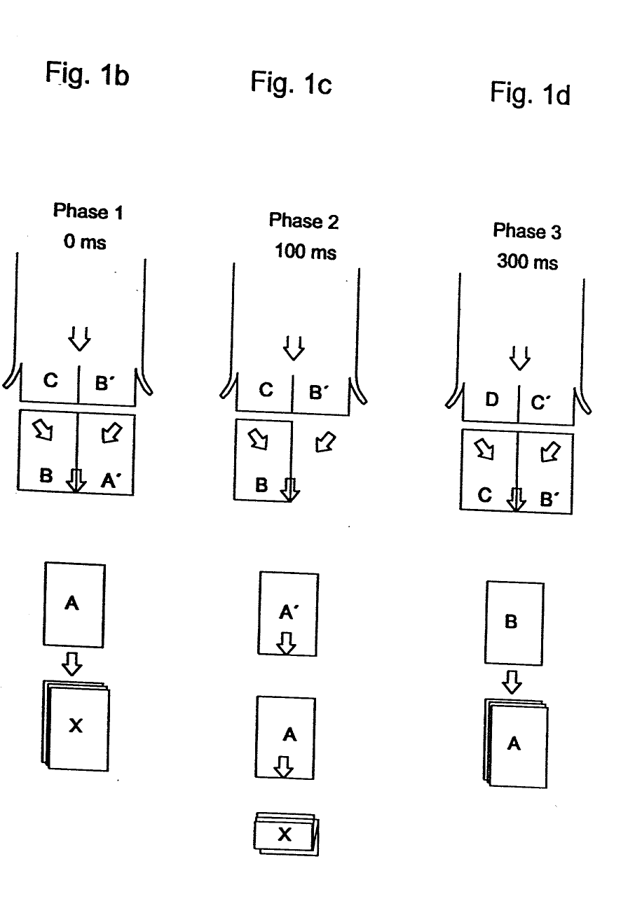

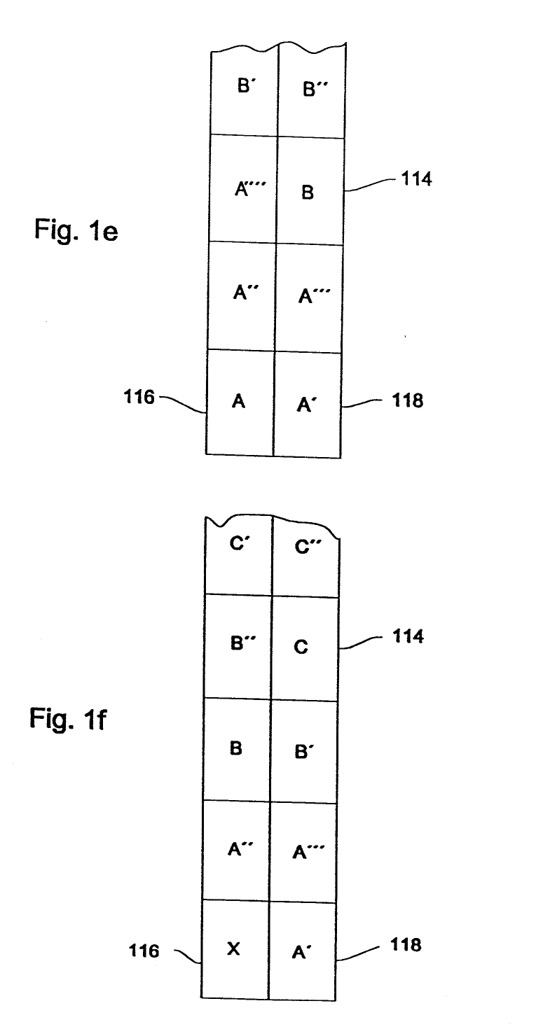

Initially, a first embodiment of the inventive method and of the inventive device shall be explained in more detail with reference to FIGS. 1 to 3.

In FIG. 1A, reference numeral 100 represents a first embodiment of the inventive device 100. The device 100 includes a sheet-feeding means 102, a sheet-transferring means (merger) 104, a stop location means 106 and a collating station 108. In the embodiment represented, collating station 108 is followed by a folding mechanism 110. It is evident that in addition to or instead of the folding mechanism, further/other paper-handling units may follow collating station 108, depending on which type of paper processing is desired. In addition, a control means 112 is provided which is connected with each of the components of device 100. In device 100, sheets, e.g. sheets of paper, which are to be processed move in a paper and/or sheet conveying direction P.

In sheet-feeding means 102, a paper web 114 fed to the same is printed upon, and subsequently the paper web 114 is cut so as to provide, at the output end of paper-feeding means 102, two individual sheets 116 and 118 arranged side by side in the sheet conveying direction P. Individual sheet 116 is arranged on the right-hand side of central axis Z of device 100 in the paper conveying direction P, and individual sheet 118 is arranged on the left-hand side in the paper conveying direction P with regard to central axis Z. Individual sheets 114, 116 arranged side by side are passed to merger 104 which transfers the same onto a common sheet track, as is indicated at 120 in FIG. 1A. Adjacent to the output end of merger 104 is stop location means 106 from where the sheets or the sheet contained therein are passed to collating station 108 so as to form the desired group of sheets there. As soon as the latter is formed, the collated sheets are taken, in the form of a stack 122, from collating station 108 to folding mechanism 110 where they are folded and, if necessary, introduced to further processing such as, for example the insertion of the folded sheets into an envelope.

Control means 112 controls the overall flow of operation of device 100 in such a manner that, if the sheets transferred by the sheet-transferring means 104 (merger) belong to the same group of sheets, transferral of these sheets to the collating station is effected. If this is not the case, the control function causes transferring of one of the sheets to collating station 108 and buffering and/or retaining the other one of the sheets in the stop locating means 106.

The sheet-feeding device 102 is, for example a combination of a printer and a cutting device or of a sheet leader which provides two separate sheets side by side for transferral to merger 104.

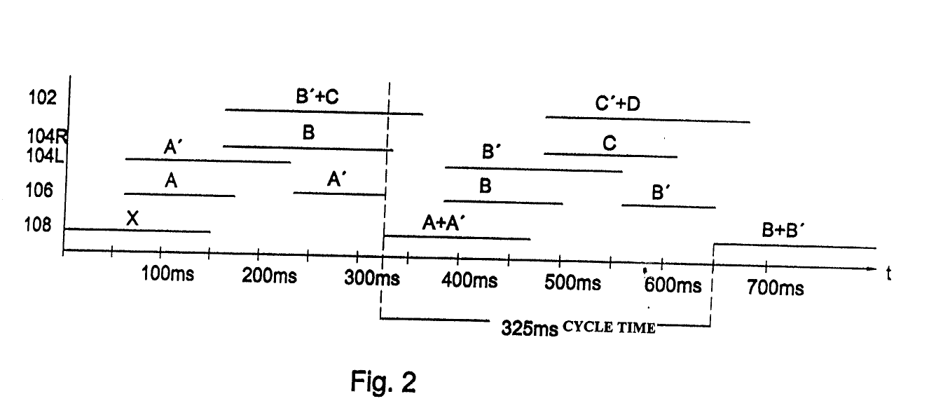

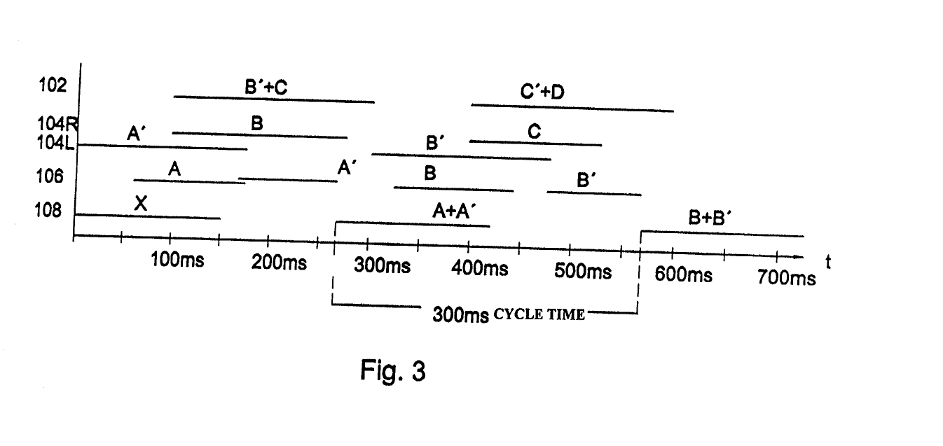

In the following, the mode of operation of device 100 in accordance with the present invention shall be explained in more detail with reference to FIGS. 1B to 1D in conjunction with FIGS. 2 and 3. FIG. 1B represents an initial situation at a time t=0 ms, which is referred to as phase 1. In this situation, a previous stack X is already contained in the collating station, sheet A of group of sheets A is at stop location 106, and sheet A′ of group of sheets A and sheet B of the subsequent group of sheets B are provided side by side at the input end of merger 104. The additional sheets B′ and C have already been provided in sheet-feeding device 102 but have not yet been fully cut.

FIG. 1C depicts the situation which presents itself at the time t=100 ms. In the meantime, stack X has been taken from collating station 108 and introduced into the subsequent folding mechanism 110, and at the same time the individual sheet A present at stop location 106 has moved to collating station 108. In this phase 2, individual sheet A′ is passing through the merger on its way to stop location 106, and sheet B continues to be provided at the input end of merger 104.

FIG. 1D depicts phase 3, which occurs 300 ms after the start of phase 1. At this time, the entire group of sheets A is contained in collating station 108, and sheet B of the subsequent group is retained at stop location 106, whereby it is made possible to simultaneously provide further individual sheets B′ and C at the input end of merger 104. At the same time, the partially cut sheets C′ and D of the further groups of sheets are already provided at the output end of sheet-feeding means 102.

With regard to the provision of the individual sheets by the sheet-feeding device, it should be pointed out that it is merely a preferred embodiment of the present invention that has been described using groups of two sheets with reference to FIG. 1, in which groups the respective individual sheets are arranged offset to one another, i.e. in different sections of paper web 114. However, the present invention is not limited to such a group formation, but instead of groups of two sheets being formed, a group may contain any desired number of individual sheets, the principles of the present application equally applying if, for example, three, four, five or more sheets are to be combined to form one group, the sheets being arranged either at the beginning of the group, at the end of the group, or at both, in a manner such that they are offset relative to the remaining sheets of the group of paper web 114, as is shown in an exemplary manner in FIGS. 1E and 1F.

In a paper web 114, as is shown, for example in FIG. 1E, the two sheets 116 and 118 are at first provided side by side in the paper conveying direction and are transferred onto the common sheet track 120 in merger 104. Initially, the transferred sheets are transferred into collection station 108, since they belong to the same group of sheets A. The same steps are carried out for all sheets of this group of sheets A until one arrives at the pair of sheets wherein one of the sheets is associated with a subsequent group of sheets, that is to say group of sheets B. As soon as one has arrived at this pair of sheets, the last sheet belonging to the current group, sheet A″″, is added to the collating station, and sheet B is retained in stop location means 106. After the collating station has been emptied, i.e. after stack 122 of group of sheets A has been moved out, sheet B, which is contained in the stop location, is transferred to the collating station, and the remaining sheets of group of sheets B are transferred to collating station 108 in accordance with the steps outlined above.

The inventive device 100 makes this possible on account of the fact that the control means is operable to control sheet-feeding means 102 and paper-transferring means 104 so as to transfer all sheets of a group of sheets into collating station 108, wherein, in case of one of the sheets of the deposited pair of sheets not belonging to the current group of sheets, the control means is operable to transfer the last sheet of the current group of sheets into the collating station and to retain the first sheet of the subsequent group in stop location means 106. After the stack of the current group of sheets has been moved out of the collating device, the control means causes the individual sheet retained to be transferred from the stop location means into the collating means, and subsequently controls the remaining components of the device so as to feed the respective sheets of this new group to the collating station.

In the embodiment represented in FIG. 1A, the inventive device is designed such that merger 104 transfers the two deposited sheets onto the common sheet track 120 in such a manner that they are either arranged behind one other in a non-shingled manner in the sheet conveying direction, as is shown in FIGS. 1C and 1D. It should be noted that the present invention is not limited to sheet-feeding means providing only two sheets, but that devices, for example a plurality of sheet leaders, which provide three or more sheets side by side in the sheet conveying direction may also be used.

In the following, the principle of operation of the inventive device, as is depicted in FIG. 1A, for collating groups of two sheets will again be briefly explained with reference to FIGS. 2 and 3, the flow charts shown in FIGS. 2 and 3 having been prepared for different configurations of the individual components of device 100.

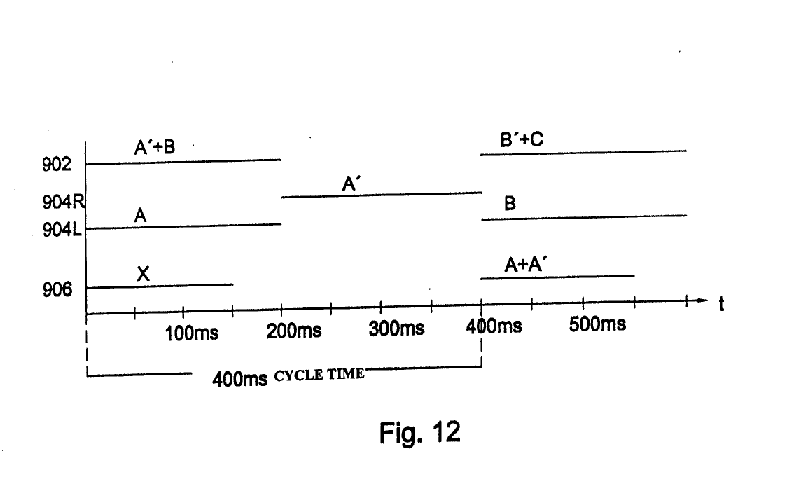

FIG. 2 shows a flow chart for device 100 with stop location 106, wherein the output times for groups of two sheets are indicated in milliseconds, these respective sheets being arranged in an uneven manner (see above). The holding-point length of stop location means 118 is approximately 330 mm, and the cutting means and/or sheet-feeding means 102 effects feeding of the sheets at a rate of approximately 2 m/s, and the merger moves the respective sheets at a rate of approximately 4 m/s to 4.5 m/s. In FIGS. 2 and 3, the times are plotted against the x axis, and the respective components are plotted against the y axis, i.e. sheet-feeding means 102, merger 104, stop location 106 and collating station 108, wherein a distinction is made, as has already been the case in FIG. 12, between the sheet which is deposited on the left-hand side of central axis Z in the sheet conveying direction P in the merger and the sheet which is deposited on the right-hand side of central axis Z in the paper conveying direction P in the merger, which is illustrated by reference numerals 104R and 104L.

In the flow chart in accordance with FIG. 2, group of sheets X, which is present in the collating station, is initialled moved out at the time t=0 ms, which takes 150 ms. A short while after starting to move group of sheets X out of collating station 108, a start is made to move an individual sheet A of group of sheets A out, which individual sheet is present at stop location 106, the moving out of the stop location taking 150 ms. At the same time as the start of moving sheet A out of stop location 106, individual sheet A′ of group of sheets A, which individual sheet A′ is deposited on the left-hand side of central axis Z in the sheet conveying direction, is moved through the merger in the direction of stop location 106, as is shown at 104L in FIG. 2. Moving a sheet out of the merger takes 170 ms.

The situation at the time t=100 ms is shown in FIG. 1C. Sheets A and A′ are moving, whereas sheet B is still stationary. The latter is not set in motion until the time t=ca. 150 ms, and passes through merger 104 (see 104R). Concurrently with the start of the motion of sheet B by merger 104, sheet-feeding means 102 is started so as to effect provision of the next sheets B′ and C at merger 104, which takes 200 ms. While the second sheet B is still passing through the merger, sheet A′ has already reached the stop location and is moved, as soon as it has reached the latter, into collating station 108 within approximately 100 ms so that at the time t=325 ms group of sheets A, which consists of individual sheets A and A′, is provided in collating station 108. As can further be seen, shortly after individual sheet A′ has been output into collating station 108, individual sheet B is inserted into stop location 106 and retained there until group of sheets A has been moved out of collating station 108. As can be seen from the further course of the flow chart, the cycle time for forming an individual group up to forming the next individual group is only 325 ms, i.e. it is 75 ms shorter than in the prior art.

With reference to FIG. 3, a further embodiment will be described in the following, wherein the configuration of the individual components of device 100 is such that further shortening of the cycle time between two groups is effected. In FIG. 3, the time t=0 ms represents that a start is made to move out group X, located in collating station 108, which takes 150 ms. At the same time, a start is made to move individual sheet A′, deposited at the input end of the merger, through the merger, which takes 170 ms. At a predetermined offset of approximately 50 ms after starting to move group X out of collating station 108, a start is made to move individual sheet A, which is already deposited at stop location 106, out of the latter, which takes 115 ms. At the time t=100 ms a start is made to move individual sheet B of the subsequent group, which individual sheet B is also deposited at the input end of the merger, through the merger, which again takes 170 ms, and at the same time a start is made to provide the next sheets B′ and C in sheet-feeding means 102, which takes 200 ms. As can further be seen from the flow chart, after 170 ms, sheet A′ is transferred to stop location 106, the output rate of which is set such that moving this sheet A′ out takes only 95 ms, so that after roughly 265 ms the group of sheets A, consisting of individual sheets A and A′, is located in collating means 108, and that at this time a start is made to move this individual group out. In a manner offset in time with regard to starting to move group A out of collating station 108, a start is made to move individual sheet B out of stop location 106 into the collating station, the individual sheet B′ of this group having already been moved in advance, as can be seen in FIG. 3. The resulting cycle time is only 300 ms in this case, i.e. it is 100 ms shorter than the cycle time required in a system in accordance with the prior art.

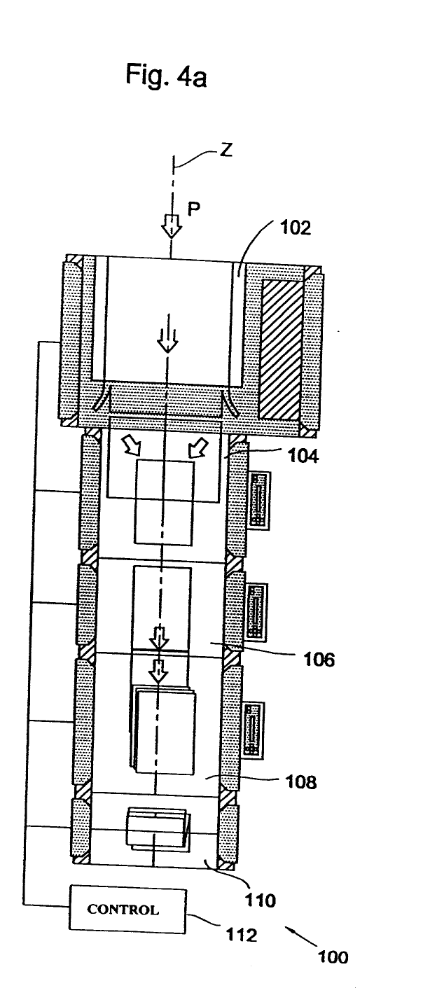

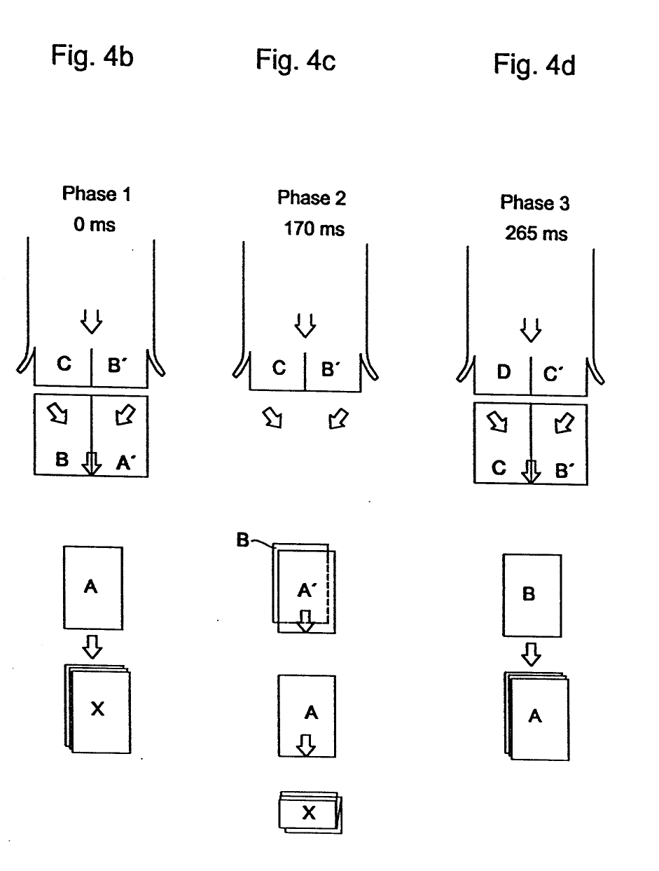

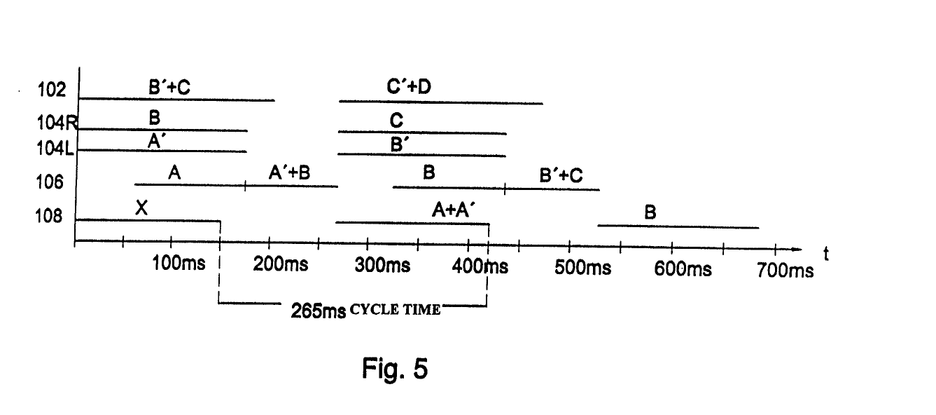

In the following, a second preferred embodiment of the present invention will be explained in more detail with reference to FIGS. 4 and 5, wherein merely the differences compared to the embodiments described with reference to FIGS. 1 to 3 are set out, and a renewed description of the elements that are already known from FIG. 1 shall not be given.

The embodiment in accordance with FIG. 4A is different from the example of FIG. 1 in that stop location means 106 is a so-called double-storey stop location for receiving two sheets placed one above the other, which leads to a further reduction in cycle time necessary for forming a group.

FIG. 4A shows the device in accordance with this embodiment, and in this case, merger 104 is operated such that the transferral the two individual sheets from the side-by-side arrangement onto the common track is effected in such a manner that the two sheets are arranged one above the other and are inserted into the double-storey stop location like this. As can be seen in FIG. 4A, the initial situation in phase 1 at the time t=0 s is identical to that in FIG. 1B, however, the difference becomes clear in FIG. 4C. In phase 2, at the time t=170 ms, both sheets B and A′, which are deposited at the input end of merger 104, were simultaneously moved in the direction of collating station 108 such that they are arranged one above the other or, at least, one above the other in a shingled manner. To what extent a complete superimposition or a shingled arrangement of the two individual sheets is desired shall depend on the specific case of application.

At this time, the previous stack X has already been moved to folding mechanism 110, and sheet A, which initially was located at the stop location, has been moved into collating station 108. Stop location 106, which is designed as a two-storey stop location, receives sheet A′ at the one level and sheet B at the other level, and passes on merely sheet A′ to collating station 108 and retains sheet B, as is represented in FIG. 4D in phase 3 at the time t=265 ms.

FIG. 5 shows the flow chart for the output times for uneven groups of two sheets, the holding-point length being used here amounting to 165 mm, and the stop location, as designed, being double-storey.

At the time t=0 ms, the initial situation is represented in which the previous stack X is located in collating station 108, individual sheets A′ and B are deposited at the input end of the merger, individual sheet A is deposited at stop location 106 and further sheets B′ and C are provided in sheet-feeding means 102 in the manner represented in FIG. 4. At the time t=0 ms, a start is made to move group X out of collating station 108, which takes 150 ms. At the same time, a start is made to move individual sheets B and A′, which are deposited at the input end of the merger, in the direction of the collating station in a simultaneous manner, which takes 170 ms. Also simultaneously, a start is made to provide subsequent sheets B′ and C through sheet-feeding means 102, which takes 200 ms. At a time t=ca. 60 ms, a start is made to move sheet A, which is located at stop location 106, out of the latter, the stop location here operating at a first speed, so that the moving out takes 115 ms. At the same time that sheet A has left stop location 106, the two sheets A′ and B are fed to stop location 106 in a double-storey manner, and the operating rate of the latter is changed to a higher value, so as to accelerate moving individual sheet A′ out of the respective holding-point level, which takes 95 ms. Individual sheet B remains at the stop location and is moved out of stop location 106 in an offset manner relative to the start of the transferral of sheets B′ and C by the merger, as has already been described above with reference to individual sheet A. As can be seen, the total cycle time for forming a group amounts to 265 ms in this example, so that an even further acceleration of the method is achieved.

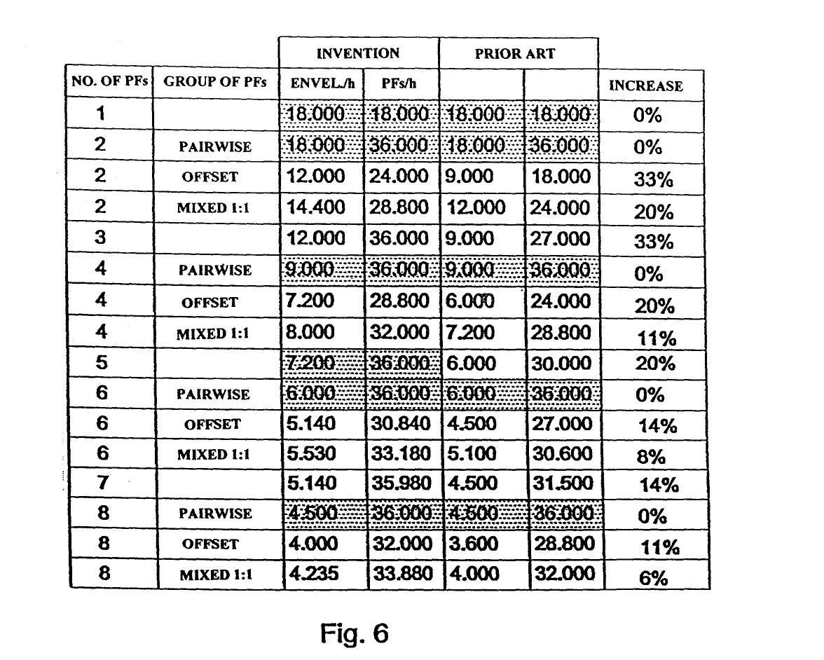

The increase which can be achieved in accordance with the present invention in comparison with conventional systems depending on the printed forms used and on the arrangement of the printed forms in the paper webs is apparent from the table in FIG. 6. As can be seen, a considerable increase compared with conventional systems results for groups of printed forms that are arranged in an offset and in a mixed manner. With a view to the mixed arrangement it should be pointed out that this expresses that 50% of printed forms are arranged in an offset manner and 50% are arranged in pairs. As can be seen, an increase in the range of 6% to 33% can be achieved as opposed to conventional systems.

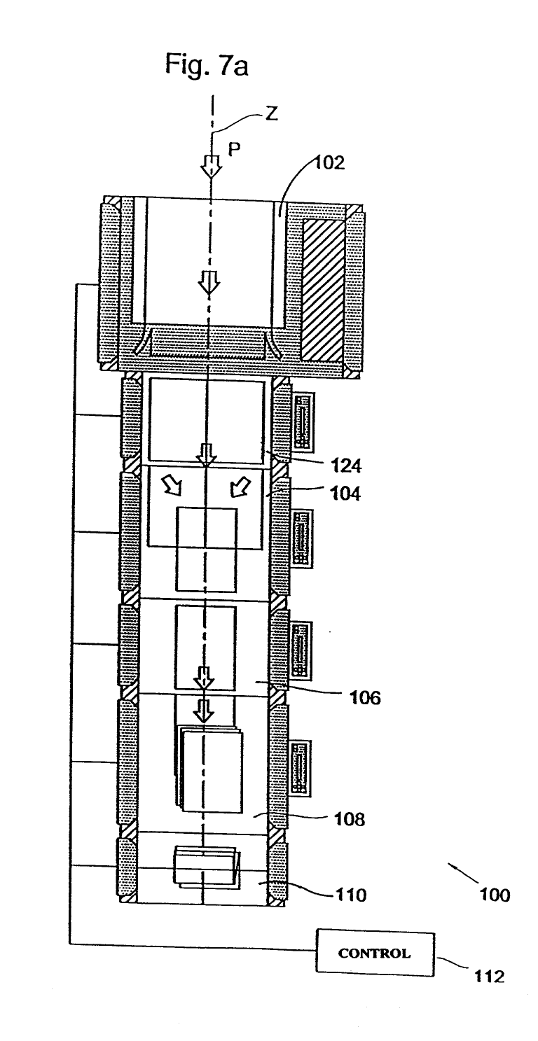

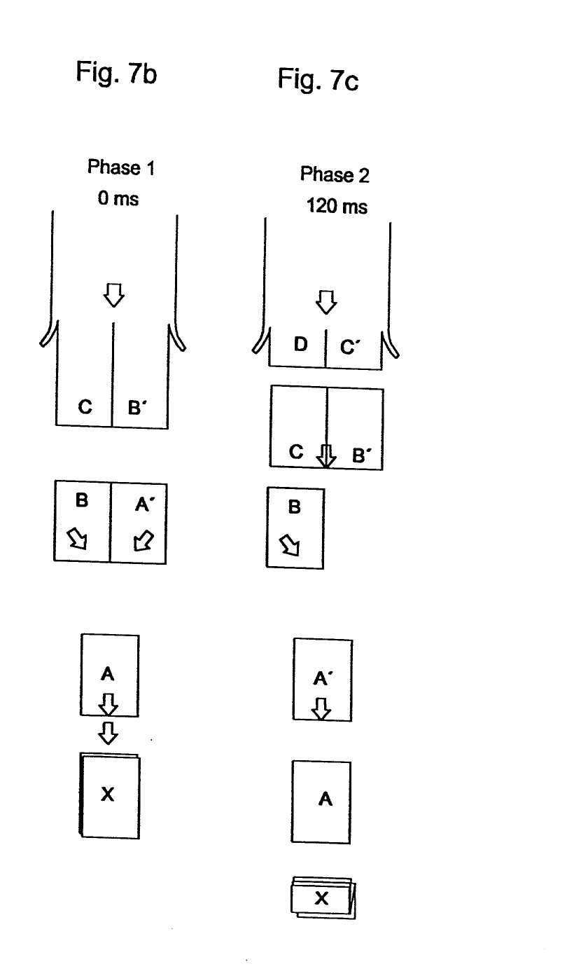

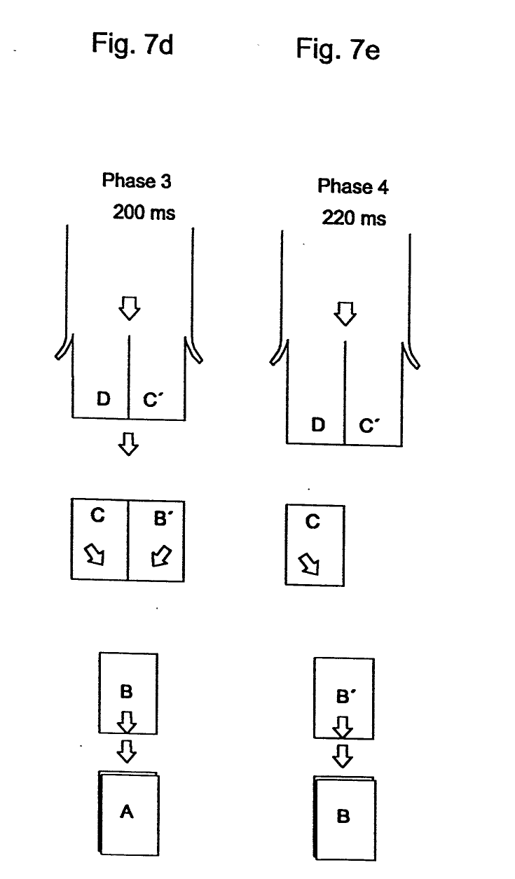

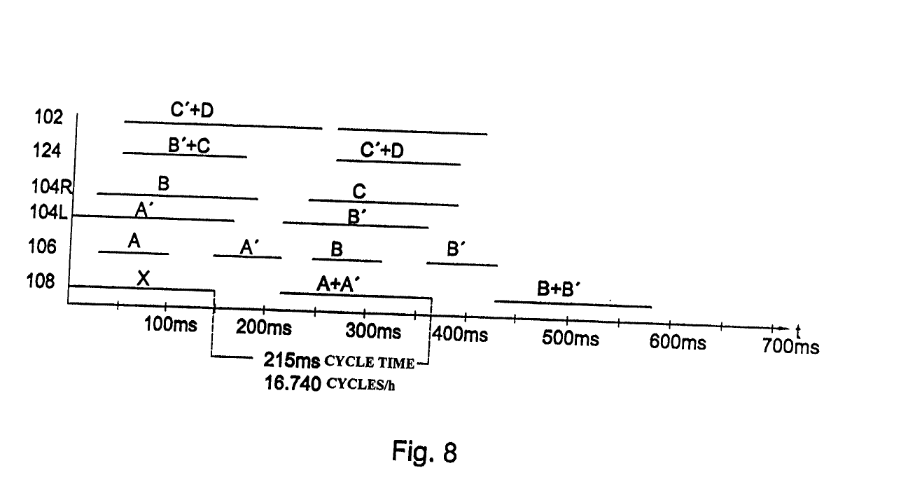

Another embodiment of the present invention shall be described below with reference to FIGS. 7 and 8. In FIG. 7A, device 100 in accordance with this embodiment is shown which essentially corresponds to that in FIGS. 1 and 4, a further stop location 124 being inserted, however, between sheet-feeding means 102 and merger 104 so as to provide decoupling of the cutting operation from the feeding operation to merger 104. The advantage of this is that at each point in time when the merger requires new paper, such feeding may be effected immediately, i.e. no more waiting is necessary until the time-consuming cutting operation (roughly 20 ms) has been completed. As soon as the sheets have been fed in merger 104, they are processed in accordance with the manner as has been described with reference to FIG. 1 or FIG. 4. FIGS. 7B to 7E show the individual sections of processing in accordance with this embodiment, and as can be seen, these differ from the previous embodiments essentially in that the merger can be provided with new sheets in a faster manner due to stop location 124, which leads to a further reduction in cycle time, as is apparent from FIG. 8.

With regard to FIG. 8 it shall be pointed out that the same defines sections 104R and 104L with regard to the merger, 104R designating the individual sheet which is provided on the right-hand side of central axis Z in paper conveying direction P, and 104L designating the individual sheet which is provided on the left-hand side of central axis Z in the paper conveying direction. At the time t=0 ms—the situation shown in FIG. 7B-the previous stack X is located in the collating station, a first sheet A is located at stop location 106, individual sheets A′ and B are located in merger 104, and the further sheets B′ and C are located at stop location 124. At the time t=0 ms, a start is made to move group X out of collating station 108, the collating station being operated such that this moving out takes roughly 150 ms. At the same time, a start is made to move individual sheet A′ provided in the merger (see reference numeral 104L) through the merger, a start is being made, in a manner offset in time, to move individual sheet A out of stop location 106, and simultaneously with starting to move individual sheet A out of the stop location, a start is made to move individual sheet B, which is also provided at the input end of the merger, through the latter, as is shown at 104R. Moving the individual sheets out of stop location 106, connected upstream from the collating station, takes roughly 70 ms, and moving the individual sheets out of the merger takes roughly 170 ms. As is apparent from FIG. 8, sheets B′ and C, which are arranged at the additional stop location 124, are moved out in a manner offset in time with regard to starting to move sheet B out of merger 104, which takes 150 ms. At the same time as the start of the moving out of the additional stop location 124, cutting machine 102 is activated so as to provide the additional sheets C′ and D and to transfer them into stop location 124, which takes roughly 200 ms.

At the time t=120 ms, the situation depicted in FIG. 7C has been achieved wherein group X is already located in folding mechanism 110, individual sheet A is located in the collating station, individual sheet A′ is being moved out of stop location 106, and individual sheet B is still passing through the merger. At this time, sheets B′ and C have already been moved out of the additional stop location 124 and are provided at the input end of the merger.

At the time t=200 ms, the situation shown in FIG. 7D results wherein both individual sheets A and A′ of group of sheets A are located in the collating station and sheet B of the subsequent group of sheets is arranged at stop location 106. As can be seen from the further course of the diagram in FIG. 8, this results in a cycle time of roughly 215 ms, which is thus again lower than the preceding one and leads to roughly 16.740 cycles per hour. Therefore, further advantages in terms of speed can be achieved by using the additional stop location 124, so that an overall improvement in speed of almost 50% as against the prior art results.

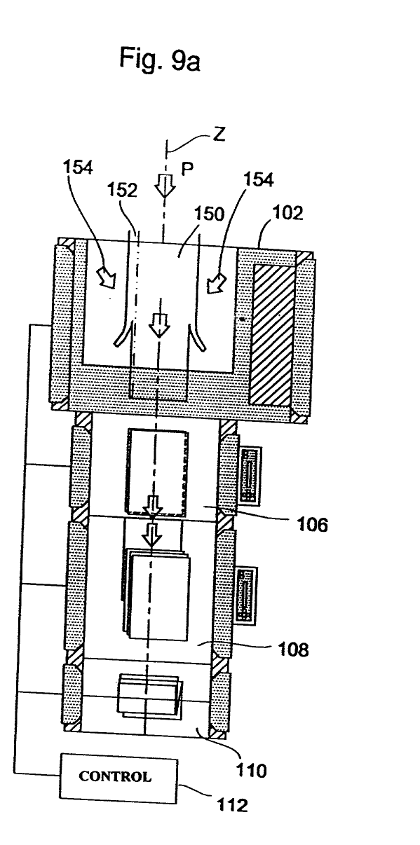

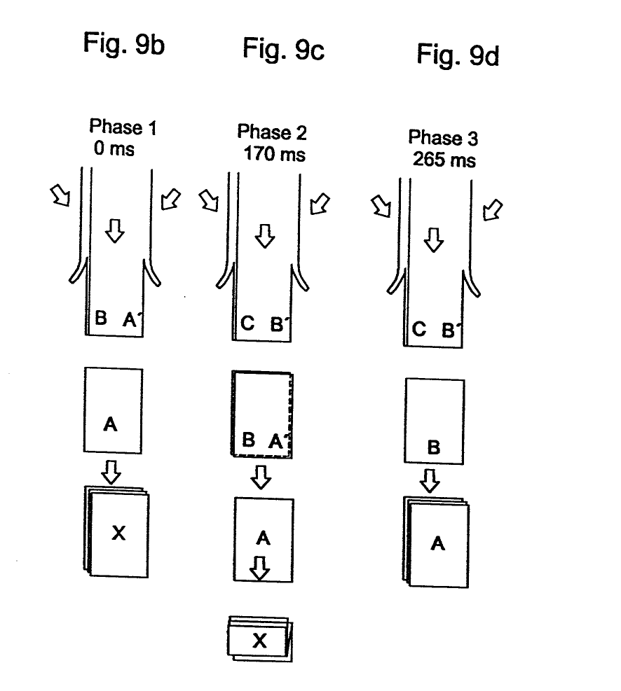

In the following, a further preferred embodiment of the present invention will be described with reference to FIG. 9, wherein like reference numerals are used for elements operating in a similar or in the same manner that have already been described with reference to the previous figures, and wherein a new description of these elements is omitted.

FIG. 9A shows the inventive device in accordance with the further embodiment including a sheet-feeding means 102, a stop location 106, a collating station 108 and an optional folding mechanism 110, the individual elements each being connected to a common control unit 112. Sheet-feeding device 102 in accordance with this embodiment is designed such that it receives two paper webs 150, 152 which are running in parallel to each other and are separate from each other, these two paper webs having already been supplied with the relevant information, for example by upstream printers or similar elements. In paper-feeding device 102 the paper webs, which are arranged side by side with regard to the paper conveying direction P and the machine's central axis Z, are transferred onto a common paper track, as is shown by arrows 154. In paper-feeding device 102, the paper webs which have thus been transferred to lie on top of one other are cut so as to provide the sheets of the individual groups which are subsequently passed on, via stop location 106, to collating station 108, from where they are passed on to be processed further, for example, in the embodiment represented, to be folded in folding mechanism 110.

The mode of operation of the device shown in FIG. 9A will be further explained by means of different operating phases with reference to FIGS. 9B to 9D. FIG. 9B shows phase 1 at the time t=0 ms, a previous stack of individual sheets X being located in the collating station and a first sheet A of group of sheets A being arranged at stop location 106 in this phase. Sheets A′ and B, which have not yet been cut, are provided at the output end of sheet-feeding means 102, the paper webs fed already having been arranged on top of one other.

FIG. 9C shows phase 2 at the time t=170 ms and, as can be seen, a stack of sheets X has moved from collating station 108 to folding mechanism 110 during the transition from phase 1 to phase 2, and, at the same time, individual sheet A has been introduced into collating station 108. During this time, the sheets A′ and B provided were also cut and introduced to stop location 106, which enables the next sheets B′ and C to be provided in feeding station 102 at this point already.

At the time t=265 ms (see FIG. 9D), group of sheets A was completed by introducing sheet A′ from stop location 106 to the collating station, and only sheet B of group of sheets B is located at stop location 106. The situation as is presented in FIG. 9D essentially corresponds to the one in FIG. 9B, except for the fact that, here, a further group has already been formed.

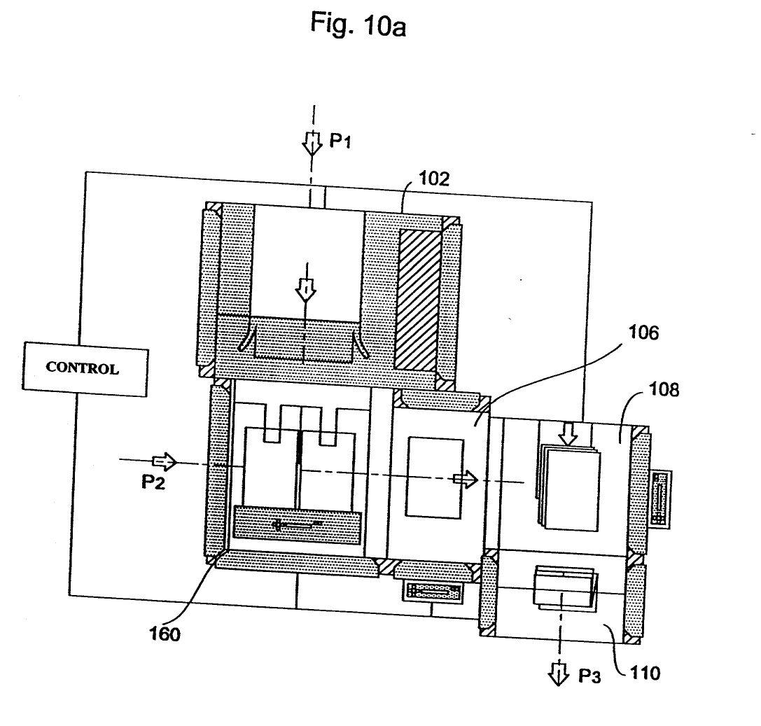

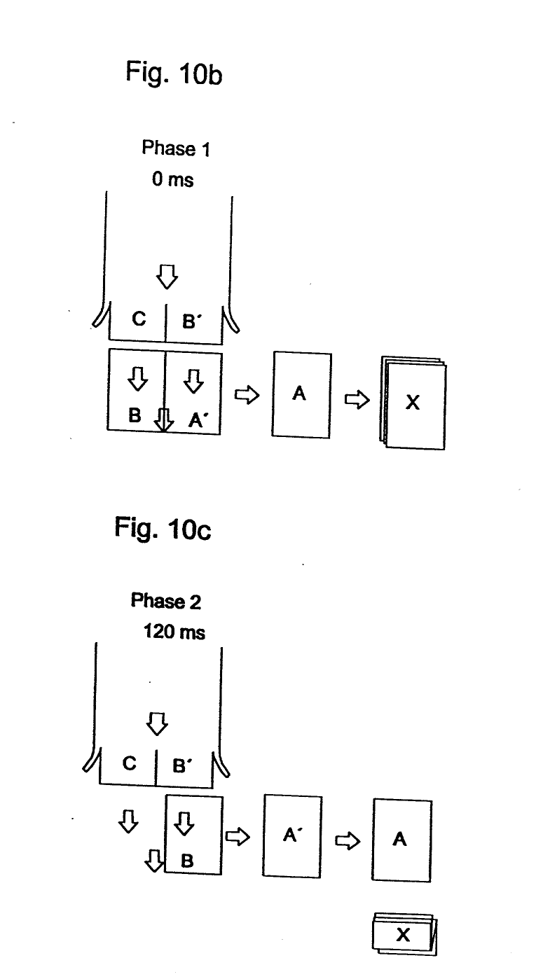

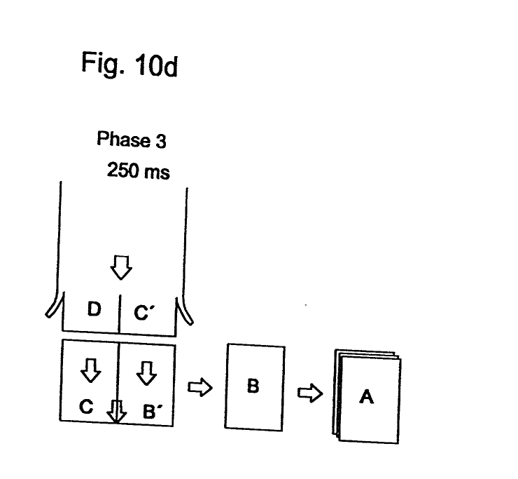

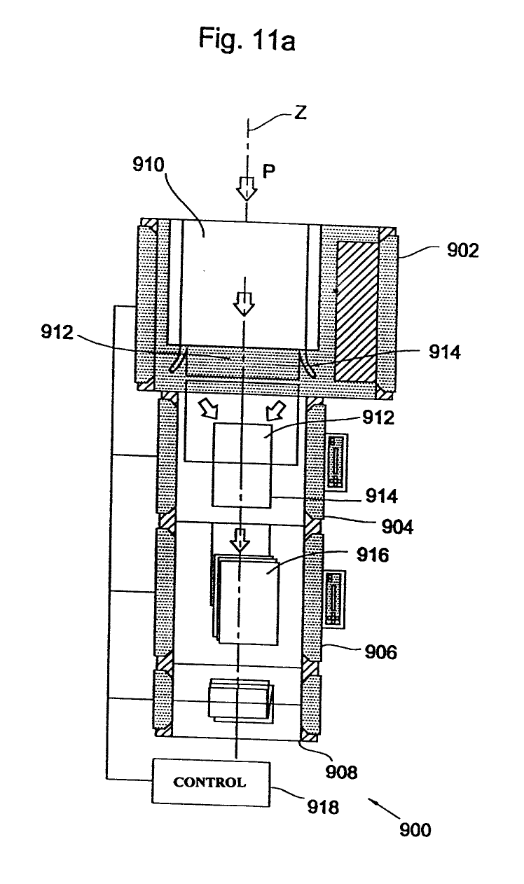

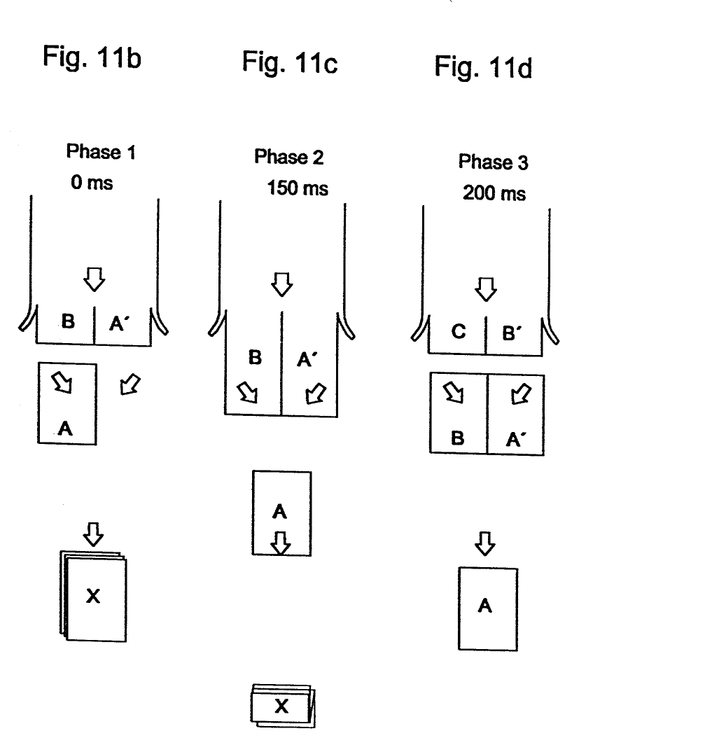

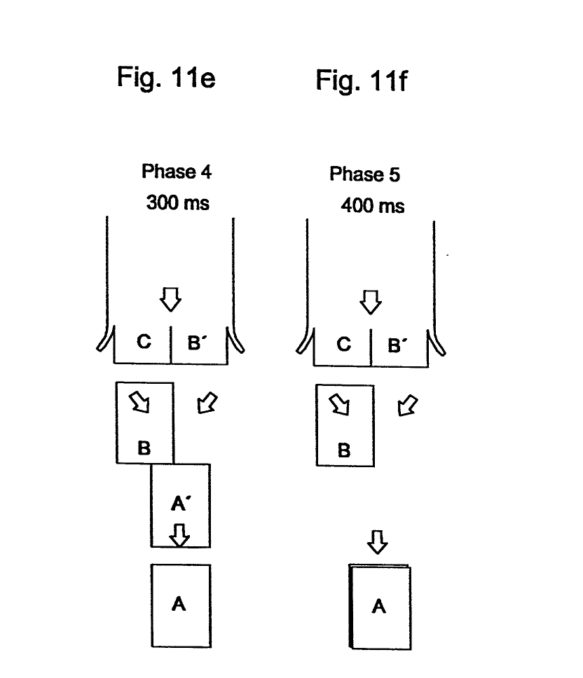

Another embodiment of the present invention will, again, be described in more detail below with reference to FIG. 10, a representation of the inventive device being shown in FIG. 10A. Like the others, this device includes a sheet-feeding device 102 which essentially corresponds to the one described above with reference to FIGS. 1A, 4A and 7A, that is, a feeding device providing individual sheets side by side in the paper conveying direction, these sheets being printed upon in sheet-feeding device 102 and cut afterwards. As can be seen from FIG. 10A, these individual sheets are fed and provided in feeding means 102 in a first paper conveying direction P1. A sequence sorter device 160 is connected downstream from paper-feeding device 102 in the first paper conveying direction P1, and this device 160 is followed, in a second paper conveying direction P2, inventive stop location 106 and, after that, by collating station 108 which, as can be seen, outputs the collated sheets to a folding mechanism 110 in a third paper conveying direction P3. Sheet-feeding device 102 transfers the individual sheets, which are arranged side by side, to sequence sorter device 160 which transfers them to stop location 106 in the second sheet conveying direction P2.

The mode of operation of this device is represented in further detail with reference to FIGS. 10B to 10D, with FIG. 10B assuming an initial situation as occurs as phase 1 at the time t=0 ms. In this situation, a previous stack of sheets X is located in the collating station, a first sheet A of group of sheets A is arranged at stop location 106, and a further sheet A′ of group of sheets A as well as a first sheet B of group of sheets B are arranged in the sequence sorter side by side with regard to the first paper conveying direction P1. At the output end of the feeding device 102, subsequent sheets B′ and C have already been provided.

In the course of roughly 120 ms, the situation represented in Fig. C occurs in phase 2, wherein stack X has been transferred from collating station 108 to folding mechanism 110, and sheet A has been transferred, at the same time, from stop location 106 into collating station 108. In addition, sheets A′ and B′ have been moved further, to be precise in the paper conveying direction P2, so that sheet A′ is arranged at stop location 106 and sheet B is arranged at the output end of the sequence sorter 160. After an additional 130 ms, the situation represented in FIG. 10D arises in phase 3 at the time t=250 ms, wherein sheet A′ has been introduced from stop location 106 to collating station 108, so that the formation of individual group A has been completed. The advantage of the present invention is therefore apparent from this example, since it can be seen that it is no longer necessary to wait until the collating station has been moved out for loading new sheets into the sequence sorter, after sheet B has been latched at stop location 106.

As can be seen from FIG. 10A, paper conveying directions P1 and P3 are essentially parallel to one another, whereas paper conveying direction P2 is essentially perpendicular to the two above paper conveying directions. However, other designs are also possible.

When compared with the systems as are known in the prior art, the present invention offers substantial advantages in terms of speed, since providing the stop location being the merger and the collating station enables the merger to be recharged with paper sooner, since the first sheet of a subsequent group is latched and/or retained at the stop location. A further advantage results from the fact that a further stop location may be arranged at the input end of the merger, so that a pair of sheets is provided at the input end of the merger at any time, so that they can immediately be fed at the merger's request, without requiring an initial performance of the time-consuming cutting steps.

What is claimed is:

1. Method for forming groups of sheets from a plurality of sheets, comprising the following steps:
(a) providing at least two sheets, respectively;
(b) if the sheets provided in step (a) belong to the same group of sheets
transferring these sheets into a common sheet track and into a collating station; and
(c) otherwise
transferring the sheet of a previous group of the sheets into a common sheet track and moving it in the direction of a stop location,
at an offset in timing as against the sheet of the previous group, transferring the other sheet of a subsequent group of the sheets into a common sheet track and moving it in the direction of the stop location,
as soon as the sheet of the previous has reached the stop location, moving it into the collating station; and
retaining the other sheet in the stop location,
the offset in timing being such that shortly after the sheet of the previous group has been output into the collating station, the sheet of the subsequent group is inserted into the stop location.

2. Method for forming groups of sheets from a plurality of sheets, comprising the following steps:
(a) providing at least two sheets, respectively;
(b) if the sheets provided in step (a) belong to the same group of sheets
transferring these sheets into a common sheet track and through a double-storey stop location into a collating station; and
(c) otherwise
simultaneous transferring of the sheets into a common sheet track and feeding the sheets into the double-storey stop location in a form in which they are arranged on top of each other,
moving the sheet of a previous group of the sheets out of the double-storey stop location into the collating station and retaining the other sheet of a subsequent group in the double-storey stop location; and
moving the sheet of the previous group out of the collating station;
moving the sheet of the subsequent group out of the double-storey stop location into the collating station in a manner offset in time as against the sheet of the previous group.

3. Method as claimed in claim 1, comprising the following step:
repeating steps (a), (b) and (c) for all sheets of a group of sheets.

4. Method as claimed in claim 1, comprising the following steps:
for all sheets of a group of sheets:
repeated performance of steps (a) and (b), and one-off performance of step (c); and
for all sheets of the next group:
transferring the sheet retained; and
repeated performance of steps (a), (b) and (c) for the remaining sheets of this group of sheets.

5. Method as claimed in claim 1, wherein the sheets are arranged side by side in a sheet conveying direction in step (a), and wherein same are transferred from the side-by-side arrangement into the common sheet track in step (a).

6. Method as claimed in claim 1, wherein the sheets are arranged side by side in a first sheet conveying direction in step (a) and are subsequently moved in the direction of stop location and collating station in a second sheet conveying direction in steps (b) and (c).

7. Method as claimed in claim 6, wherein the first sheet conveying direction is perpendicular to the second sheet conveying direction.

8. Method as claimed in claim 1, wherein the sheets are arranged on top of one other in a sheet conveying direction in step (a).

9. Method as claimed in claim 5, wherein the two sheets are transferred, in step (c), such that they are arranged, in the common sheet track, behind one other in a non-shingled manner in sheet conveying direction or that they are arranged behind one other in a shingled manner in sheet conveying direction or that they are arranged on top of one other in sheet conveying direction.

10. Method as claimed in claim 5, comprising the following step after step (a):
retaining the two sheets, which have been provided in step (a), at a further stop location.

11. Method as claimed in claim 1, wherein step (a) includes the following steps:
printing upon a paper web;
cutting the printed paper web so as to provide the two sheets.

12. Method as claimed in claim 1, wherein three or more sheets are provided in step (a).

13. Apparatus for forming groups of sheets from a plurality of sheets, comprising:
a sheet-feeding means, wherein two sheets are arranged, for providing the sheets;
a sheet-transferring means for transferring the sheets into a common sheet track;
a stop location means receiving one or several sheets from the sheet-transferring means;
a collating station collating sheets of a group of sheets; and
a control means which
if the sheets provided by the sheet-feeding means belong to the same group of sheets
effects the transferral of these sheets into a common sheet track and into a collating station, and
otherwise
the transferral of the sheet of a previous group of the sheets into a common sheet track and the moving of same in the direction of a stop location,
at an offset in timing as against the sheet of the previous group, the transferral of the other sheet of a subsequent group of the sheets into a common sheet track and the moving of same in the direction of the stop location,
as soon as the sheet of the previous group has reached the stop location, the moving of same into the collating station;
retaining the other sheet in the stop location,
the offset in timing being such that shortly after the sheet of the previous group has been output into the collating station, the sheet of the subsequent group is inserted into the stop location.

14. Apparatus for forming groups of sheets from a plurality of sheets, comprising:
a sheet-feeding means wherein two sheets are arranged, for providing the sheets;
a sheet-transferring means for transferring the sheets into a common sheet track;
a stop location means receiving one or several sheets from the sheet-transferring means;
a collating station collating sheets of a group of sheets; and
a control means which
if the sheets provided by the sheet-feeding means belong to the same group of sheets
effects the transferral of these sheets into a common sheet track and through a double-storey stop location into a collating station, and
otherwise
the simultaneous transferral of the sheets into a common sheet track and the feeding of the sheets into the double-storey stop location,
the moving of the sheet of a previous group of the sheets out of the double-storey stop location into the collating station and the retention of the other sheet of a subsequent group in the double-storey stop location; and
the moving of the sheet of the previous group out of the collating station;
the moving of the sheet of the subsequent group out of the double-storey stop location into the collating station in a manner offset in time as against the sheet of the previous group.

15. Apparatus as claimed in claim 13, wherein the control means controls the sheet-feeding means so as to transfer all sheets of a group of sheets into the collating station.

16. Apparatus as claimed in claim 13, wherein the control means
controls the sheet-feeding means so as to transfer all sheets of a group of sheets into the collating station and to transfer one sheet of a next group of sheets into the stop location means and retain it; and
controls the stop location means so as to transfer the sheet retained in the stop location means into the collating station, and controls the sheet-feeding means and the sheet-transferring means so as to transfer all remaining sheets of the next group into the collating station.

17. Apparatus as claimed in claim 13, wherein the sheet-feeding means arranges the sheets side by side in a sheet conveying direction and wherein the sheet-transferring means is arranged between the sheet-feeding means and the stop location, and wherein same receives the sheets provided from the sheet-feeding means and transfers them from the side-by-side arrangement into a common sheet track.

18. Apparatus as claimed in claims 13, wherein the sheet-feeding means arranges the sheets side by side in a first sheet conveying direction, and wherein the sheet-transferring means is arranged between the sheet-feeding means and the stop location, sheet-transferring means moving the sheets in a manner such that they are arranged behind one another in a second sheet conveying direction in the direction of the stop location and the collating station.

19. Apparatus as claimed in claim 18, wherein the first sheet conveying direction is essentially perpendicular to the second sheet conveying direction.

20. Apparatus as claimed in claim 13, wherein the sheet-feeding means provides the sheets on top of one another in a sheet conveying direction.

21. Apparatus as claimed in claim 17, wherein the sheet-transferring means transfers the sheets, which have been fed by the sheet-feeding means, into the common sheet track such that they are arranged behind one other in a non-shingled manner in the sheet conveying direction, that they are arranged behind one other in a shingled manner in the sheet conveying direction, or that they are arranged on top of one other in the sheet conveying direction.

22. Apparatus as claimed in claim 17, comprising:
a further stop location means arranged between the sheet-feeding means and the sheet-transferring means.

23. Apparatus as claimed in claim 13, wherein the sheet-feeding means includes a printer and a cutting machine.

24. Apparatus as claimed in claim 13, wherein the sheet-feeding means provides three or more sheets.
